(19) United States
(12) Patent Application Publication
(10) Pub. No.: US 2006/0089450 A1
(43) Pub. Date: Apr. 27, 2006

(54) Radiation curable coating composition

(76) Inventors: Johan F.G.A Jansen, Geleen (NL); Marko Dorschu, Beek (NL); Olav M Aagaard, Geleen (NL); Gerry K Noren, Algonquin, IL (US)

Correspondence Address: MAYER, BROWN, ROWE & MAW LLP, 1909 K STREET, N.W., WASHINGTON, DC, 20006, US

(21) Appl. No.: 10/514,016

(22) PCT Filed: May 16, 2003
(86) PCT No.: PCT/NL03/00365

§ 371 Date: Nov. 4, 2005

Related U.S. Application Data
(60) Provisional application No. 60/380,867, filed on May 17, 2002.

(51) Int. Cl. C08F 8/30

(52) U.S. Cl. 524/555; 524/556

(57) ABSTRACT

The present invention relates to a radiation curable coating composition comprising (A) a compound according to P-(D-(meth)acrylate)ₙ having a number average molecular weight (Mn) of at least 500 kg/kmol, wherein n=240, P=oligomeric or polymeric backbone, and D comprises an urethane group and an heterocyclic group, said heterocyclic group having a Boltzmann average dipole moment of at least 2.5 Debye, and (B) a reactive diluent. The heteorocylic group is preferably an oxazolidone group. The invention further relates to a method for making a resin composition comprising a compound comprising an oxazolidone group and an (meth)acrylate group, said method comprising a reaction step introducing the (meth)acrylate group into the compound, wherein said reaction step is carried out in the presence of an antioxidant.

### FIELD OF THE INVENTION

The present invention relates to a radiation curable coating composition comprising special compounds containing an urethane group and an acrylate group, a method of producing the compounds and a resin composition containing the compounds obtainable by the method. The invention further relates to a group of the special compounds.

### BACKGROUND OF THE INVENTION

In the production of optical fibers, a resin coating is applied immediately after drawing of the glass fibers for protection and reinforcement of the glass fiber. Generally, two coatings are applied, a soft primary coating layer of a flexible resin (low modulus and low Tg) which is coated directly on the glass surface and a secondary coating layer of a rigid resin relatively (higher modulus and higher Tg) which is provided over the primary coating layer. Often, for identification purposes, the fibers will be further coated with an ink, which is a curable resin comprising a colorant (such as a pigment and/or a dye), or the secondary coating may be a colored secondary coating (i.e, comprise a colorant).

Several coated (and optionally inked) optical fibers can be bundled together to form a so-called optical fiber ribbon, e.g., four or eight coated (and optionally inked) optical fibers are arranged in a plane and secured with a binder to produce a ribbon structure having a rectangular cross section. Said binder material for binding several optical fibers to produce the optical fiber ribbon structure is called a ribbon matrix material. In addition, a material for the further binding of several optical fiber ribbons to produce multi-core optical fiber ribbons is called a bundling material.

In order to obtain proper protection and reinforcement of the glass fiber good adhesion between the coating and the glass fiber is essential. Therefore it is desirable to develop a coating composition that after being applied to the glass fiber and cured shows improved adhesion.

Another very important characteristic required nowadays for curable resins used as coating materials (for protective or identification purposes) for optical fibers is to have a cure speed that is sufficiently high to be applicable at the currently used and increasing optical fiber drawing speeds while still being cured thoroughly. At present, in the production of optical fibers and optical fiber assemblies, one of the limitations on how fast the production line can be operated is the cure speed of the coatings and/or binders. Accordingly, it is desirable to develop coatings and/or binders with faster cure speed. Moreover, this improved cure speed should be obtained without sacrificing the chemical and mechanical properties of the cured coating.

Besides having a high cure speed, the coating should preferably also fulfil many other requirements, in particular: exhibiting very little physical change over a long period of time and also over wide temperature ranges; having acceptable resistance to heat and light (and thus, showing acceptable aging properties such as a low degree of yellowing), to hydrolysis, to oil, and to chemicals such as acids and alkalis; absorbing only a relatively small amount of moisture and water; producing little hydrogen gas which adversely affects optical fibers; and the like.

Resins that cure on exposure to radiation such as ultraviolet radiation are favored in the industry, due to their fast cure, enabling the coated fiber to be produced at high speed. In many of these radiation curable resin compositions, use is made of urethane oligomers having reactive terminal groups (such as an acrylate or methacrylate functionality, herein after referred to as (meth)acrylate functionality) and a polymer backbone. Generally, these compositions may further comprise reactive diluents, photoinitiators, and optionally suitable additives.

An object of the present invention is to provide a radiation curable coating composition suitable for the coating of optical glass fibers that after curing shows a very good adhesion to the optical glass fiber.

A further object is to provide a radiation curable coating composition that subjected to radiation shows a high curing speed.

From U.S. Pat. No. 3,979,406 the preparation of a group of compounds comprising an oxazolidone group, an urethane group and an acrylate group is known. Only generic uses are mentioned for the compounds.

### SUMMARY OF THE INVENTION

The present invention further provides a radiation curable coating composition comprising

(A) a compound according to P-(D-acrylate)ₙ having a number average molecular weight (Mn) of at least 500 kg/kmol, wherein n=2-40, P=an oligomeric or polymeric backbone, and D comprises an urethane group and an heterocyclic group, said heterocyclic group having a Boltzmann average dipole moment of at least 2.5 Debye, and

(B) a reactive diluent.

The present invention provides a radiation curable coating composition comprising:
(A) a compound comprising an oxazolidone group, an urethane group and an acrylate group and having a molecular weight of at least 500 kg/kmol and
(B) a reactive diluent.

The present invention further relates to a radiation curable coating composition comprising a radiation curable oligomer, a reactive diluent and a photoinitiator in such amounts that said composition, when cured, shows (i) a cure speed of less than about 0.17 J/cm² when measured by a dose-modulus test, or a cure speed of less than about 0.11 sec when measured by real time DMA as the time needed to reach a G′of 2×10⁴ Pa, and

(ii) a dry adhesion of at least about 250 g/in.

The compound, comprising an ozazolidone group, an urethane group and an acrylate group and having a molecular weight of at least 500 kg/kmol is further referred to as oxazolidone group containing compound.

Surprisingly, the radiation curable coating composition of the present invention when applied as a coating on to an optical glass fiber and cured, has a very good adhesion compared to known compositions. Furthermore the radiation curable coating composition according to the invention shows a very high curing speed compared to the known compositions.

The compositions of the invention are preferably designed for use as a colored or uncolored optical fiber single protective coating, primary (or inner primary) coating, secondary (or outer primary) coating or related optical fiber protective materials such as matrix or bundling materials. Such optical fiber coatings have their own set of unique performance requirements, which distinguish them from conventional applications.

Further, the compounds according to the present invention and the resin compositions according to the present invention can be designed for use as optical media adhesives and lacquers, as superconductor coatings, as adhesives, sealants and potting compounds for electronics, as lenses and coatings for lenses, or as hardcoats. For example, the resin compositions may be used as DVD adhesives resulting in improved adhesion by bonding of the metal layers.

The invention also relates to a special method for the preparation of oxazolidone group containing compounds and to a new group of oxazolidone group containing compounds.

### DETAILED DESCRIPTION OF THE PRESENT INVENTION

The radiation curable coating composition according to the present invention preferably comprises besides (A) and (B):

(C) one or more photoinitiators and/or

(D) one or more additives.

Preferably, the radiation curable coating composition according to the invention has a cure speed (when measured by a dose-modulus test) of about 0.16 J/cm² or less, more preferably about 0.14 J/cm² or less, even more preferably about 0.12 J/cm² or less, particularly preferred about 0.10 J/cm² or less, and most preferred about 0.08 J/cm² or less.

Preferably, the radiation curable coating composition according to the invention has a cure speed (when measured by real time DMA as the time needed to reach a G′of 2×10⁴ Pa) of about 0.10 sec or less, more preferably about 0.09 sec or less, even more preferably about 0.08 sec or less, particularly preferred about 0.06 sec or less.

Preferably, the radiation curable coating composition according to the invention has a dry adhesion of at least about 300 g/in, more preferably at least about 350 g/in, even more preferred at least about 400 g/in, particularly preferred at least about 450 g/in, and most preferred the adhesion of the coating to the glass is so high that the coating film breaks before delamination occurs.

(A) Heterocyclic Group Containing Compounds and Oxazolidone Group Containing Compounds.

According to one embodiment of the present invention, a preferred key element in obtaining the improved radiation curable composition according to the invention is the presence of the heterocyclic group containing compound in the composition, said heterocyclic group having a Boltzmann average dipole moment of at least 2.5 Debye, more preferably at least 3.0 Debye, even more preferred at least 3.5 Debye, particularly preferred at least 4.0 Debye and most preferred at least 4.5 Debye.

Examples of heterocyclic groups having high dipole moments and falling under the scope of the present invention are components having a functional group chosen from the group consisting of 5- or 6-membered ring phosphates, 5- or 6-membered ring phosphites, 4-membered ring lacton, 5-membered ring lacton, 6-membered ring lacton, 5-membered ring carbonate, 6-membered ring carbonate, 5-membered ring sulphate, 6-membered ring sulphate, 5 ring sulphoxide, 6-membered ring sulphoxide, 6-membered ring amide, 5-membered ring urethane, 6-membered ring urethane, 7-membered ring urethane, 5-membered ring urea, 6-membered ring urea, and 7-membered ring urea. Especially preferred are components that have a urethane group in the molecule and a 5-membered ring phosphate, 6-membered ring phospate, 5-membered ring phosphite, 6-membered ring phosphite 4 ring lacton, 5-membered ring lacton, 6-membered ring lacton, 5-membered ring carbonate, 6-membered ring carbonate, 5-membered ring sulphate, 6-membered ring sulphate, 5 ring sulphoxide, 6-membered ring sulphoxide, 5-membered ring amide, 6-membered ring amide, 7 ring amide, 5-membered ring urethane, 6-membered ring urethane, 7-membered ring urethane, 5-membered ring urea, 6-membered ring urea, 7-membered ring urea group.

Also very reactive and preferred components are components having both a carbonate functionality in the molecule and a functionality selected from the list consisting of a 5 ring phosphate, 6-membered ring phosphate, 5-membered ring phosphite, 6-membered ring phosphite, 4-membered ring lacton, 5-membered ring lacton, 6-membered ring lacton, 5-membered ring carbonate, 6-membered ring carbonate, 5-membered ring sulphate or sulphite, 6-membered ring sulphate or sulphite, 5-membered ring sulphite, 6-membered ring sulphite, 5 ring sulphoxide, 6-membered ring sulphoxide, 5-membered ring amide, 5membered ring imide, 6-membered ring amide, 7 ring amide, 5-membered ring imide, 6-membered ring imide, 5-membered ring thioimide, 6-membered ring thioimide, 5-membered ring urethane, 6-membered ring urethane, 7-membered ring urethane, 5-membered ring urea, 6-membered ring urea and 7-membered ring urea group.

Preferred compositions according to the invention are radiation curable coating compositions, wherein said heterocyclic group is an oxazolidone group containing compound.

Very suitable compositions according to the invention are radiation curable coating compositions, wherein the compound, comprising an oxazolidone group, an urethane group and an (meth)acrylate group, is a compound according to Form. I 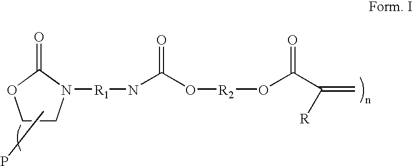
in which
P=oligomeric or polymeric backbone which is connected to either the 4 or 5 position of the oxazolidone
n=2-40
R=H, C₁-C₅ alkyl
R₁=C₁-C₃₀ alkyl, cycloalkyl, aryl, alkylaryl
R₂=C₁-C₁₂alkyl, cycloalkyl, aryl, alkylaryl, alkoxy alkyl, alkoxy aryl
or a compound according to Form. II: 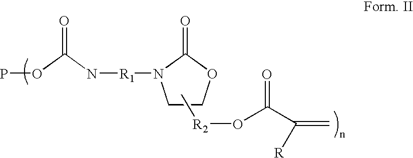
in which:
P=oligomeric or polymeric backbone
n=2-40
R=H, C₁-C₅alkyl
R₁=C₁-C₃₀ alkyl, cycloalkyl, aryl, alkylaryl
R₂=C₁-C₁₂ alkyl, cycloalkyl, aryl, alkylaryl, alkoxy alkyl, alkoxy aryl, which is connected to either the 4 or 5 position of the oxazolidone.

Preferably n=2-10, more preferably n=2. Preferably R=H or CH₃. Preferably R₁ is a C₂-C₂₀alkyl, cycloalkyl, aryl or arylalkyl, more preferably R₁ is cycloalkyl, most preferably R₁ is cyclohexyl. In a further preferred embodiment, R₁ is according to (1):

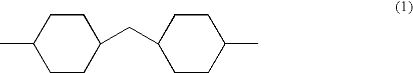

Preferably R₂=methyl, ethyl, 1-propyl, 2-propyl, butyl, ethoxyethyl. In a still further preferred embodiment, R₁ is according to (1) and R₂ is ethyl, since compositions comprising this compound show excellent processability.

Suitable polymers and oligomers P are, for example, polymers and oligomers obtained by an addition reaction or a condensation reaction.

Although the terms oligomer and polymer are used in this specification, no clear distinction exists between oligomer and polymer. Oligomers tend to be on the low side of the molecular weight range and polymers tend to be on the high side of the molecular weight range. Hereinafter, the terms “oligomer” and “polymer” still be used interchangeably.

The polymers and oligomers can be, for example, linear, branched, have a comb, star or ladder structure. Also dendrimers and hyperbranched polymers are useful.

Suitable addition polymers and oligomers P include polymers and oligomers derived from monomers such as for example (meth)acrylate, acrylamide, styrene, ethylene, propylene, maleic acid, cyanoacrylate, vinylacetate, vinylether, vinylchloride, vinylsilane and mixtures thereof.

Suitable condensation polymers and oligomers P include, for example, polyesters, polylactones, polyamides, polyesteramides, polyethers, polyesterethers, polyurethanes and polyurethane-urea.

Suitable linear polymers and oligomers P include, for example, polyethers derived from diols, polyethylene, poly-MMA, polyesters derived from diols and difunctional acids and/or mono-hydroxy acids.

Suitable branched polymers and oligomers P include, for example, polyethers comprising at least one trifunctional alcohol unit, polyesters comprising at least one tri- or tetrafunctional alcohol unit and/or one tri/tetra-functional acid unit.

Suitable dendrimers are disclosed in for example EP-A-575596, EP-A-707611, EP-A-741756, EP-A-672703, Angew. Chem. Int. Ed. Eng. 1994, 33, 2413, Angew. Chem. Int Ed. Eng. 1990, 29, 138, Angew. Chem. Int. Ed. Eng. 1993, 32, 1308 and Angew. Chem. Int. Ed. Eng. 1992, 31, 1200.

Suitable hyperbranched polymers include, for example, condensation polymers containing β-hydroxyalkylamide groups and having a weight average molecular mass of ≧800 g/mol.

In case of compounds according to Form. I, P is preferably derived form an epoxy functional, more preferably a glycidyl functional polymer or oligomer. Epoxy functional polymers or oligomers can for example be obtained by epoxydation of remaining unsaturations of addition polymers or oligomers.

Examples glycidyl functional polymers or oligomers are polytetrahydrofuran (THF) diglycidyl ether, polypropylene glycol diglycidyl ether, ethoxylated bis phenol A diglycidyl ethers and propoxylated bisphenol A diglycidyl ether.

Preferably the glycidyl functional polymers and oligomers are in their turn derived from polyols.

In case of compounds according to Form. II, P is preferably directly derived from a polyol.

Examples of suitable polyols are polyether polyols, polyester polyols, polycarbonate polyols, polycaprolactone polyols, acrylic polyols, and other polyols. These polyols may be used either individually or in combinations of two or more. There are no specific limitations to the manner of polymerization of the structural units in these polyols. Any of random polymerization, block polymerization, or graft polymerization is acceptable.

Given as examples of the polyether polyols are polyethylene glycol, polypropylene glycol, polypropylene glycol-ethyleneglycol copolymer, polytetramethylene glycol, polyhexamethylene glycol, polyheptamethylene glycol, polydecamethylene glycol, and polyether diols obtained by ring-opening copolymerization of two or more ion-polymerizable cyclic compounds. Here, given as examples of the ion-polymerizable cyclic compounds are cyclic ethers such as ethylene oxide, isobutene oxide, tetrahydrofuran, 2-methyltetrahydrofuran, 3-methyltetrahydrofuran, dioxane, trioxane, tetraoxane, cyclohexene oxide, styrene oxide, epichlorohydrin, isoprene monoxide, vinyl oxetane, vinyl tetrahydrofuran, vinyl cyclohexene oxide, phenyl glycidyl ether, butyl glycidyl ether, and glycidyl benzoate. Specific examples of combinations of two or more ion-polymerizable cyclic compounds include combinations for producing a binary copolymer such as tetrahydrofuran and 2-methyltetrahydrofuran, tetrahydrofuran and 3-methyltetrahydrofuran, and tetrahydrofuran and ethylene oxide; and combinations for producing a ternary copolymer such as a combination of tetrahydrofuran, 2-methyltetrahydrofuran, and ethylene oxide, a combination of tetrahydrofuran, butene-1-oxide, and ethylene oxide, and the like. The ring-opening copolymers of these ion-polymerizable cyclic compounds may be either random copolymers or block copolymers.

Included in these polyether polyols are products commercially available under the trademarks, for example, PTMG 1000, PTMG2000 (manufactured by Mitsubishi Chemical Corp.), PEG#1000 (manufactured by Nippon Oil and Fats Co., Ltd.), PTG650 (SN), PTG1000 (SN), PTG2000 (SN), PTG3000, PTGL1000, PTGL2000 (manufactured by Hodogaya Chemical Co., Ltd.), PEG400, PEG600, PEG1000, PEG1500, PEG2000, PEG4000, PEG6000 (manufactured by Daiichi Kogyo Seiyaku Co., Ltd.) and Pluronics (by BASF).

Polyester diols obtained by reacting a polyhydric alcohol and a polybasic acid are given as examples of the polyester polyols. As examples of the polyhydric alcohol, ethylene glycol, polyethylene glycol, tetramethylene glycol, polytetramethylene glycol, 1,6-hexanediol, 3-methyl-1,5-pentanediol, 1,9-nonanediol, 2-methyl-1,8-octanediol, and the like can be given. As examples of the polybasic acid, phthalic acid, dimer acid, isophthalic acid, terephthalic acid, maleic acid, fumaric acid, adipic acid, sebasic acid, and the like can be given.

These polyester polyol compounds are commercially available under the trademarks such as MPD/IPA500, MPD/IPA1000, MPD/IPA2000, MPD/TPA500, MPD/TPA1000, MPD/TPA2000, Kurapol A-1010, A-2010, PNA-2000, PNOA-1010, and PNOA-2010 (manufactured by Kuraray Co., Ltd.).

As examples of the polycarbonate polyols, polycarbonate of polytetrahydrofuran, poly(hexanediol carbonate), poly(nonanediol carbonate), poly(3-methyl-1,5-pentamethylene carbonate), and the like can be given.

As commercially available products of these polycarbonate polyols, DN-980, DN-981 (manufactured by Nippon Polyurethane Industry Co., Ltd.), Priplast 3196, 3190, 2033 (manufactured by Unichema), PNOC-2000, PNOC-1000 (manufactured by Kuraray Co., Ltd.), PLACCEL CD220, CD210, CD208, CD205 (manufactured by Daicel Chemical Industries, Ltd.), PC-THF-CD (manufactured by BASF), and the like can be given.

Polycaprolactone diols obtained by reacting ε-caprolactone and a diol compound are given as examples of the polycaprolactone polyols having a melting point of 0° C. or higher. Here, given as examples of the diol compound are ethylene glycol, polyethylene glycol, polypropylene glycol, polypropylene glycol, tetramethylene glycol, polytetramethylene glycol, 1,2-polybutylene glycol, 1,6-hexanediol, neopentyl glycol, 1,4-cyclohexanedimethanol, 1,4-butanediol, and the like.

Commercially available products of these polycaprolactone polyols include PLACCEL 240, 230, 230ST, 220, 220ST, 220NP1, 212, 210, 220N, 210N, L230AL, L220AL, L220PL, L220PM, L212AL (all manufactured by Daicel Chemical Industries, Ltd.), Rauccarb 107 (by Enichem), and the like.

As examples of other polyols, ethylene glycol, 1,4-butanediol, 1,5-pentanediol, 1,6-hexanediol, polyoxyethylene bisphenol A ether, polyoxypropylene bisphenol A ether, polyoxyethylene bisphenol F ether, polyoxypropylene bisphenol F ether, and the like can be given.

As these other polyols, those having a alkylene oxide structure in the molecule, in particular polyether polyols, are preferred. Specifically, polyols containing polytetramethylene glycol and copolymer glycols of butyleneoxide and ethyleneoxide are particularly preferred.

The reduced number average molecular weight derived from the hydroxyl number of these polyols is usually from about 50 to about 15,000, and preferably from about 1,000 to about 8,000.

Given as examples of the polyisocyanate used for the oxazolidone group containing compound are 2,4-tolylene diisocyanate, 2,6-tolylene diisocyanate, 1,3-xylylene diisocyanate, 1,4-xylylene diisocyanate, 1,5-naphthalene diisocyanate, m-phenylene diisocyanate, p-phenylene diisocyanate, 3,3′-dimethyl-4,4′-diphenylmethane diisocyanate, 4,4′-diphenylmethane diisocyanate, 3,3′-dimethylphenylene diisocyanate, 4,4′-biphenylene diisocyanate, 1,6-hexane diisocyanate, isophorone diisocyanate, methylenebis(4-cyclohexyl isocyanate), 2,2,4-trimethylhexamethylene diisocyanate, bis(2-isocyanato-ethyl)fumarate, 6-isopropyl-1,3-phenyl diisocyanate, 4-diphenylpropane diisocyanate, hydrogenated diphenylmethane diisocyanate, hydrogenated xylylene diisocyanate, tetramethyl xylylene diisocyanate, lysine isocyanate, and the like. These polyisocyanate compounds may be used either individually or in combinations of two or more. Preferred polyisocyanates are 1,6-hexane diisocyanate, isophorone diisocyanate, methylenebis(4-cyclohexylisocyanate) and hydrogenated diphenylmethane diisocyanate. These isocyanates result in compositions having very good processability.

Examples of the hydroxyl group-containing (meth)acrylate used in the oligomer, include, (meth)acrylates derived from (meth)acrylic acid and epoxy and (meth)acrylates comprising alkylene oxides, more in particular, 2-hydroxy ethyl (meth)acrylate, 2-hydroxypropyl(meth)acrylate and 2-hydroxy-3-oxyphenyl(meth)acrylate. Acrylate functional groups are preferred over methacrylates. Further examples are given in U.S. Pat. No. 3,979,406, which is incorporated herein by reference.

In case of compounds according to Form. II, it is possible that the hydroxy (meth)acrylates are transferred into epoxy (meth)acrylates, by epoxidizing the hydroxyl group of the hydroxy (meth)acrylates.

It is also possible that P is P′ comprising two or more blocks of R It is possible that the blocks are the same or different.

The number average molecular weight of the heterocyclic group (preferably, oxazolidone) containing compound used in the composition of the present invention is preferably in the range from about 800 to about 20,000, more preferably from 1,200 to 12,000, and more preferably from about 2,200 to about 8,000. Particularly preferred for primary coatings are heterocyclic group (preferably, oxazolidone) containing compounds or oligomers having a number average molecular weight ranging from 2,200 to 5,500, more preferably from 2,500 to 4,500, even more preferred from 2,700 to 4,000.

The heterocyclic group (preferably, oxazolidone) group containing compound is suitably used in an amount from about 10 to about 95 wt %, and preferably from about 20 to about 80 wt %, relative to the total weight of the coating composition of the total amount of (A) and (B). When the composition is used as a coating material for optical fibers, the range from about 20 to about 80 wt %, more preferably from about 30-about 70 wt. % is particularly preferable to ensure excellent coatability, as well as superior flexibility and long-term reliability of the cured coating.

It is also possible that the composition according to the invention besides to the heterocyclic group (preferably, oxazolidone) group containing compound (A) comprises an oligomer (E), said oligomer (E) being chosen from an urethane (meth)acrylate oligomer and/or another oligomer, for example polyester (meth)acrylate, epoxy (meth)acrylate, polyamide (meth)acrylate, siloxane polymer having a (meth)acryloyloxy group, a reactive polymer obtained by reacting (meth)acrylic acid and a copolymer of glycidyl methacrylate and other polymerizable monomers, and the like. Particularly preferred are bisphenol A based (meth)acrylate oligomers such as alkoxylated bisphenol-A-di(meth)acrylate and diglycidyl-bisphenol-A-di(meth)acrylate. Preferably for the radiation curable coating composition according to the invention the ratio of components (A)/(E) is at least 1, more preferably at least 2, still more preferably at least 8.

Besides the above-described components, further curable oligomers or polymers (E) may be added to the curable coating composition of the present invention to the extent that the characteristics of the liquid curable resin composition are not adversely affected.

Preferred oligomers (E) are polyether based (meth)acrylate oligomers, polycarbonate (meth)acrylate oligomers, polyester (meth)acrylate oligomers, alkyd (meth)acrylate oligomers and acrylated acrylic oligomers. More preferred are the urethane-containing oligomers thereof. Even more preferred are polyether urethane (meth)acrylate oligomers and urethane (meth)acrylate oligomers using blends of the above polyols, and particularly preferred are aliphatic polyether urethane (meth)acrylate oligomers. The term “aliphatic” refers to a wholly aliphatic polyisocyanate used. However, also urethane-free (meth)acrylate oligomers, such as urethane-free (meth)acrylated acrylic oligomers, urethane-free polyester (meth)acrylate oligomers and urethane-free alkyd (meth)acrylate oligomers are also preferred.

The invention also relates to preferred methods for the preparation of oxazolidone group containing compounds, and preferred methods for the preparation of a resin composition comprising said compound.

A method for the preparation of compounds according to Form. II is known from U.S. Pat. No. 3,979,406. However, the resin composition obtained by the method disclosed in U.S. Pat. No. 3,979,406 shows the disadvantage that the viscosity is very high. Therefore the resin composition is less suitable for the preparation of a curable coating composition according to the invention.

In the process according to the invention the reaction step introducing the (meth)acrylate group into the oxazolidone group containing compound is carried out in the presence of an antioxidant.

In this way a resin composition is obtained having a lower viscosity, so that the composition is very suitable for the preparation of the compositions according to the invention.

Preferably, the method according to the present invention is a method for preparing a resin composition comprising a compound comprising an oxazolidone group and an (meth)acrylate group, more preferably, said compound further comprises an urethane group.

The oxazolidone group containing compounds prepared according to the method of the present invention preferably have a polydispersity D, as characterised by the ratio Mw/Mn (wherein Mw is the weight average molecular weight and Mn is the number average molecular weight), of about 10 or less, more preferably D is about 8 or less, even more preferred about 5 or less and most preferred about 3.5 or less.

The gel fraction of the resin composition comprising the oxazolidone containing compound as prepared according to the method of the present invention is preferably about 5% or less, more preferably about 4% or less, and particularly preferred about 3% or less. The gel fraction is measured by filtrating off the non-soluble, gelled fraction of the resin composition and weightin said fraction.

The method according to the invention is particularly suitable for preparing a resin composition comprising an oxazolidone comprising compound according to Form. I or according to Form. II or an oxazolidone (meth)acrylate difunctional monomer according to Form. III: 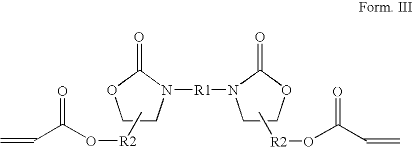
in which:
R=H, C₁-C=alkyl
R₁=C₁-C₃₀ alkyl, cycloalkyl, aryl, alkylaryl
R₂=C₁-C₁₂ alkyl, cycloalkyl, aryl, alkylaryl, alkoxy alkyl, alkoxy aryl, which is connected to either the 4 or 5 position of the oxazolidone.

Suitable antioxidants can for instance be metal based, amine based, phosphine based, sulphide based or phenol based.

Examples of metal based antioxidants are for instance zinc dialkyl thiocarbamates, nickel dialkyl thiocarbamates, zinc-2-mercapto-toluimidazole examples of amine based antioxidants are for instance N,N-diphenyl-p-phenylene diamine, dioctyl diphenyl amine, N,N′-di-sec-butyl-p-phenylene diamine, naphtyl phenyl amine.

Examples of phosphine based antioxidants are for instance tris nonylphenyl phosphite, trilauryl phosphite, di-iso octyl phosphite, di-iso decyl phenyl phosphite, triphenyl phosphite, tris (di propylene glycol) phosphite, diphenyl phosphite, bis(2,4-di-t-butyl-phenyl) pentaerythritol diphosphite.

Examples of sulphide based antioxidants are for instance dilauryl thiodipropionate, di octadecyl disulphide.

Examples of phenol based antioxidants are for instance hydroquinone, methyl hydroquinone, 2,6-dibutyl hydroquinone, diamyl hydroquinone, 2-t-butyl-4-methyl phenol, butylated hydroxyanisole, 2,6-di-t-butyl-4-methyl phenol, 2,6-di-t-butyl-4-di methyl aminomethyl phenol, 2,6-diphenyl-4-octadecyl cyclo oxy phenol, diethyl-(3,5-di-t-butyl-4-hydroxy benzyl phosphate, propyl gallate, 4-methyl-2,6-bis(2-phenylethenyl) phenol, 2,6-di-t-butyl phenol, bisphenol A.

Preferred are the phenolic antioxidants. Preferred phenolic antioxidants include di-t-butyl hydroxy toluene and 2,6-dibutyl-hydroquinone.

The antioxidants are for example used in a quantity of 500-10,000 ppm, preferably in a quantity of 800-2000 ppm.

A still further improved method according to the invention is obtained if during the reaction step introducing the (meth)acrylate group into the oxazolidone group containing compound oxygen or an oxygen containing gas mixture, preferably air, is lead into and eventually through the reaction mixture. In this way the resin composition so obtained is even more suitable for the preparation of the compositions according to the invention.

Preferably dry oxygen or a dry oxygen containing gas mixture is used. Preferably the oxygen or gas mixture comprises less than 0.1 wt. %, more preferably less than 0.03 wt. %, even more preferably 0.01 wt. % of water, particularly preferred the water content is lower or even as low as possible.

The amount of oxygen used preferably is such that at least the same amount of oxygen is dissolved in the reaction mixture as antioxidant (on molar basis).

In the method of preparation of the oxazolidone group containing compounds according to the invention, subsequent reaction steps are preferably carried out in such a sequence that the (meth)acrylate group is introduced into the compound during the last reaction step. In this way the coating composition so obtained is even more suitable for the preparation of the compositions according to the invention.

The compounds according to Form. I are preferably produced by first reacting the polyol with an epoxy group forming compound, such as for example epi chlore hydrin. In this way, a glycidyl functional polyol is formed. After that, the so obtained compound is reacted with a diisocyanate in the presence of an oxazolidone forming catalyst. Finally, the so obtained compound comprising free isocyanate groups is reacted with an hydroxy (meth)acrylate in the presence of an urethane forming catalyst. How to perform each individual step is known to person skilled in the art.

Compounds of Form. II are preferably produced by, in a first step reacting the polyol with a diisocyanate, in the presence of a urethane forming catalyst, and, in a second step, reacting the so obtained compound with an epoxy functional (meth)acrylate, preferably a glycidyl functional (meth)acrylate, in the presence of an oxazolidone forming catalyst.

Compounds of Form. III are preferably produced by reacting a diisocyanate with an epoxy functional (meth)acrylate, preferably a glycidyl functional (meth)acrylate in the presence of an oxazolidone forming catalyst.

Examples of oxazolidone forming catalysts are tertiary amines like dimethyl benzylamine, dimethylcyclohexyl amine, tetra methyl ethylene diamine, N-methyl morpholine, 1,8-diaza bicyclo-(5,4,0)-7-undecene, 1,4-diaza bicylo (2,2,2) octane, pyridine, quinoline imidazole or lewis acids like quaternary ammonium salts for instance tetra methyl ammonium bromide or tetra ethyl ammonium iodide, quarternairy phosphonium salts like tetrabutyl phosphonium bromide. Preferrably a metal based Lewis acid is used, like for example quarternary antimonium salts like tributyl antimonium diiodide, tetraethyl antimonium bromide, metal alkoxylates for instance lithium butoxide, sodium butoxide, magnesium phenoxide or aluminum phenoxide, halides of alkali, alkaline metals and metals of the third group of the periodic table for instance lithium chloride, lithium bromide, magnesium chloride, iron chloride, aluminum chloride or zinc chloride, tin salts and complexes for instance trialkyltin halide, tin chloride, tin octoate, dioctyl tin oxide, DBTDL or organoalkyls or organo alkoxylates for instance diethyl zinc trimethyl aluminia or zinc dicarboxylates and mixtures thereof. Most preferably a Lithium based Lewis acid is used.

According to a more preferred embodiment the Lewis acid is combined with a Lewis base for instance phosphine, phosphine oxides and phosphates like triphenyl phosphine, triphenyl phosphine oxide, tributyl phosphine oxide, tris (dimethyl amino) phosphine oxideor tris (2-ethylhexyl) phosphine oxide, triethyl phosphate. As lewis base also tertiary amines can be applied. The lewis base and the lewis acid can be mixtures of lewis bases and lewis acids respectively.

The reaction is for example carried out at a temperature of 100-150° C. and at a pressure of one atmosphere. Preferably no solvent is used during the reaction.

Preferably the reaction step forming the oxazolidone group is carried out in the presence of an antioxidant. In this way a coating composition having high transparency is obtained. Examples of antioxidants are given above. Preferred in this reaction step are the phosphine antioxidants.

In the reaction step forming the urethane group, a urethane forming catalyst such as for example copper naphthenate, cobalt naphthenate, zinc naphthenate, di-n-butyl tin dilaurate, triethylamine, and triethylenediamine-2-methyltriethyleneamine, is usually used in an amount from about 0.01 to about 1 wt % of the total amount of the reactant. The reaction is carried out at a temperature from about 10 to about 90° C., and preferably from about 30 to about 80° C.

The invention also relates to a resin composition obtainable by the process according to the invention.

The present invention also relates to the compounds according to Form. I.

Compounds according to Form. I proved to be very advantageous for use in the composition according to the invention as processability of the composition is very good due to its favorable low viscosity, while the further good properties of the composition are maintained.

(B) Reactive Diluent

Suitable reactive diluents are exemplified herein below.

Polymerizable vinyl monomers such as polymerizable monofunctional vinyl monomers containing one polymerizable vinyl group in the molecule and polymerizable polyfunctional vinyl monomers containing two or more polymerizable vinyl groups in the molecule may be added to the liquid curable resin composition of the present invention.

Given as specific examples of the polymerizable monofunctional vinyl monomers are vinyl monomers such as N-vinyl pyrrolidone, N-vinyl caprolactam, vinyl imidazole, and vinyl pyridine; (meth)acrylates containing an alicyclic structure such as isobornyl (meth)acrylate, bornyl (meth)acrylate, tricyclodecanyl (meth)acrylate, dicyclopentanyl (meth)acrylate, dicyclopentenyl (meth)acrylate, and cyclohexyl (meth)acrylate; benzyl (meth)acrylate, 4-butylcyclohexyl (meth)acrylate, acryloylmorpholine, 2-hydroxyethyl (meth)acrylate, 2-hydroxypropyl (meth)acrylate, 2-hydroxybutyl (meth)acrylate, methyl (meth)acrylate, ethyl (meth)acrylate, propyl (meth)acrylate, isopropyl (meth)acrylate, butyl (meth)acrylate, amyl (meth)acrylate, isobutyl (meth)acrylate, t-butyl (meth)acrylate, pentyl (meth)acrylate, isoamyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, decyl (meth)acrylate, isodecyl (meth)acrylate, undecyl (meth)acrylate, dodecyl (meth)acrylate, lauryl (meth)acrylate, stearyl (meth)acrylate, isostearyl (meth)acrylate, tetrahydrofurfuryl (meth)acrylate, butoxyethyl (meth)acrylate, ethoxydiethylene glycol (meth)acrylate, benzyl(meth)acrylate, phenoxyethyl(meth)acrylate, polyethylene glycol mono(meth)acrylate, polypropylene glycol mono(meth)acrylate, methoxyethylene glycol (meth)acrylate, ethoxyethyl (meth)acrylate, methoxypolyethylene glycol (meth)acrylate, methoxypropylene glycol (meth)acrylate, diacetone(meth)acrylamide, isobutoxy methyl(meth)acrylamide, N,N-dimethyl(meth)acrylamide, t-octyl(meth)acrylamide, dimethylaminoethyl (meth)acrylate, diethylaminoethyl (meth)acrylate, 7-amino-3,7-dimethyloctyl (meth)acrylate, N,N-diethyl(meth)acrylamide, N,N-dimethyl amino propyl(meth)acrylamide, hydroxy butyl vinyl ether, lauryl vinyl ether, cetyl vinyl ether, 2-ethylhexyl vinyl ether, acrylate monomers shown by the following formula (2), 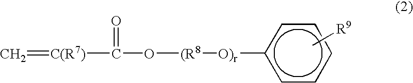
wherein R⁷ is a hydrogen atom or a methyl group, R⁸ is an alkylene group having 2-6, and preferably 2-4 carbon atoms, R⁹ is a hydrogen atom or an organic group containing 1-12 carbon atoms or an aromatic ring, and r is an integer from 0 to 12, and preferably from 1 to 8.

Given as examples of the polymerizable polyfunctional vinyl monomers are the following (meth)acrylate compounds: trimethylolpropane tri(meth)acrylate, pentaerythritol tri(meth)acrylate, ethylene glycol di(meth)acrylate, tetraethylene glycol di(meth)acrylate, polyethylene glycol di(meth)acrylate, 1,4-butanediol di(meth)acrylate, 1,6-hexanediol di(meth)acrylate, neopentyl glycol di(meth)acrylate, trimethylolpropanetrioxyethyl (meth)acrylate, tris(2-hydroxyethyl)isocyanurate tri(meth)acrylate, tris(2-hydroxyethyl)isocyanurate di(meth)acrylate, bis(hydroxymethyl)tricyclodecane di(meth)acrylate, di(meth)acrylate of a diol which is an addition compound of ethylene oxide or propylene oxide to bisphenol A, di(meth)acrylate of a diol which is an addition compound of ethylene oxide or propylene oxide to hydrogenated bisphenol A, epoxy(meth)acrylate obtained by the addition of (meth)acrylate to diglycidyl ether of bisphenol A, diacrylate of polyoxyalkylene bisphenol A, and triethylene glycol divinyl ether.

Preferred reactive diluents are alkoxylated alkyl substituted phenol (meth)acrylate, such as ethoxylated nonyl phenol (meth)acrylate, vinyl monomers such as vinyl caprolactam, isodecyl (meth)acrylate, and alkoxylated bisphenol A di(meth)acrylate such as ethoxylated bisphenol A diacrylate.

(C) Photoinitiator

The liquid curable resin composition of the present invention can be cured by radiation, and preferably, one or more photo-polymerization initiators are used. In addition, a photosensitizer or synergist may be added as required. Given as examples of the photo-polymerization initiator are 1-hydroxycyclohexylphenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl methyl ketal, 1-(4-isopropylphenyl)-2-hydroxy-2-methylpropan-1-one, 2-hydroxy-2-methyl-1-phenylpropan-1-one, thioxanethone, diethylthioxanthone, 2-isopropylthioxanthone, 2-chlorothioxanthone, 2-methyl-1-[4-(methylthio)phenyl]-2-morpholino-propan-1-one, 2,4,6-trimethylbenzoyldiphenylphosphine oxide, bis-(2,6-dimethoxybenzoyl)-2,4,4-trimethylpentylphosphine oxide, bis-(2,4,6-trimethylbenzoyl)-phenylphosphine oxide and the like. Mixtures of these photo-polymerization initiators may also be used.

Examples of commercially available products of the photo-polymerization initiator include IRGACURE 184, 369, 651, 500, 907, 1700, 1750, 1850, 819, CG24-61, Darocur I116, 1173 (manufactured by Ciba Specialty Chemicals Co., Ltd.), Lucirin LR8728 (manufactured by BASF), Ebecryl P36 (manufactured by UCB), and the like.

Given as examples of the photosensitizer or synergist are triethylamine, diethylamine, N-methyldiethanoleamine, ethanolamine, 4-dimethylaminobenzoic acid, methyl 4-dimethylaminobenzoate, ethyl 4-dimethylaminobenzoate, isoamyl 4-dimethylaminobenzoate, and the like. As commercially available products of the photosensitizer, for example, Ebecryl P102, 103, 104, and 105 (manufactured by UCB) are given. Use of mixtures of synergists is also possible.

The amount of the polymerization initiator used here is preferably in the range from 0.1 to 10 wt %, and more preferably from 0.5 to 7 wt %, of the total amount of the components for the resin composition.

Beside the above-described components, other curable oligomers or polymers may be added to the liquid curable resin composition of the present invention to the extent that the characteristics of the liquid curable resin composition are not adversely affected.

(D) Additives

An amine compound can be added to the liquid curable resin composition of the present invention to prevent generation of hydrogen gas, which causes transmission loss in the optical fibers. As examples of the amine which can be used here in, diallylamine, diisopropylamine, diethylamine, diethylhexylamine, and the like can be given.

In addition to the above-described components, various additives such as antioxidants, UV absorbers, light stabilizers, silane coupling agents, coating surface improvers, heat polymerization inhibitors, leveling agents, surfactants, colorants, preservatives, plasticizers, lubricants, solvents, fillers, aging preventives, and wettability improvers can be used in the liquid curable resin composition of the present invention, as required.

Examples of silane coupling agents include aminopropyltriethoxysilane, mercaptopropyltrimethoxy-silane, and methacryloxypropyltrimethoxysilane, and commercially available products such as SH6062, SH6030 (manufactured by Toray-Dow Corning Silicone Co., Ltd.), and KBE903, KBE603, KBE403 (manufactured by Shin-Etsu Chemical Co., Ltd.);

The description on radiation curable compositions can also apply to colored compositions, being either a colored single, a colored primary, or a secondary outer primary composition, an ink composition or a colored matrix or bundling material. The colorant can be a pigment or dye. The pigment can be any pigment suitable for use in pigmented colored optical fiber coatings. Preferably, the pigment is in the form of small particles and is capable of withstanding UV-radiation.

Pigments can be conventional or organic pigments as disclosed in, for example, Ullman's Encyclopedia of Industrial Chemistry, 5^{th} Ed., Vol. A22, VCH Publishers (1993), pages 154-155, the complete disclosure of which is hereby fully incorporated by reference. The pigment can be selected based on, for example, whether the composition is a colored secondary, ink coating or matrix material. Ink coatings are typically more heavily pigmented.

General classes of suitable colorants include, among others, inorganic white pigments; black pigments; iron oxides; chronium oxide greens; iron blue and chrome green; violet pigments; ultramarine pigments; blue, green, yellow, and brown metal combinations; lead chromates and lead molybdates; cadmium pigments; titane pigments; pearlescent pigments; metallic pigments; monoazo pigments, diazo pigments; diazo condensation pigments; quinacridone pigments, dioxazine violet pigment; vat pigments; perylene pigments; thioindigo pigments; phthalocyanine pigments; and tetrachloroindolinones; azo dyes; anthraquinone dyes; xanthene dyes; and azine dyes. Fluorescent pigments can also be used.

Preferably, the pigment has a mean particle size of not more than about 1 μm. The particle size of the commercial pigments can be lowered by milling if necessary. The pigment is preferably present in an amount of about 1 to about 10% by weight, and more preferably in an amount of about 3 to about 8% by weight.

Instead of pigments also dyes can be used if sufficiently color stable. Reactive dyes are particularly preferred. Suitable dyes include polymethine dyes, di and triarylmethine dyes, aza analogues of diarylmethine dyes, aza (18) annulenes (or natural dyes), nitro and nitroso dyes, aza dyes, anthraquinone dyes and sulfur dyes. These dyes are well known in the art.

All these additives may be added to the compositions according to the invention in an amount that is usual for the additive when used in a particular application, such as for example in optical fiber coatings.

Physical Characteristics

The viscosity of the liquid curable resin composition of the present invention is usually in the range from about 200 to about 20,000 cP, and preferably from about 2,000 to about 15,000

The radiation curable composition of the present invention may be formulated to be used as a single coating, a primary coating, a secondary coating, a matrix material or bundling material (all of which can be colored or not), or as an ink. In particular, the radiation-curable compositions of the present invention may be formulated such that the composition after cure has a modulus as low as 0.1 MPa and as high as 2,000 MPa or more. Those having a modulus in the lower range, for instance, from 0.1 to 10 MPa, preferably 0.1 to 5 MPa, and more preferably 0.5 to less than 3 MPa are typically suitable for primary coatings for fiber optics. In contrast, suitable compositions for secondary coatings, inks and matrix materials generally have a modulus of above 50 MPa, with secondary coatings tending to have a modulus more particularly above 100 up to 1,000 MPa and matrix materials tending to be more particularly between about 50 MPa to about 200 MPa for soft matrix materials, and between 200 to about 1500 MPa for hard matrix materials. The radiation-curable composition of the present invention may be formulated such that the composition after cure has a Tg ranging from −70° C. to 30° C.

The glass transition temperature (Tg), measured as the peak tan-delta determined by dynamic mechanical analysis (DMA), can be optimized depending on the particulars of the application. The glass transition temperature may be from 10° C. down to −70° C. or lower, more preferably lower than 0° C. for compositions formulated for use as primary coatings and 10° C. to 120° C. or higher, more preferably above 30° C., for compositions designed for use as secondary coatings, inks and matrix materials.

Elongation and tensile strength of these materials can also be optimized depending on the design criteria for a particular use. For cured coatings formed from radiation-curable compositions formulated for use as inner primary coatings on optical fibers, the elongation-at-break is typically greater than 65%, preferably greater than 80%, more preferably the elongation-at-break is at least 110%, more preferably at least 150% but not typically higher than 400%. For coatings formulated for outer primary coatings, inks and matrix materials the elongation-at-break is typically between 6% and 100%, and preferably higher than 10%.

The invention is further explained by way of experiments, without being limited by that.

Description of Analytical Methods

The compounds prepared in the examples and comparative experiment were analysed by:
Infra red spectroscopy (Bruker TMISS 55),
NMR (Bruker 400 MHz, the spectra were recorded in deuterated chloroform, ¹³C NMR were recorded with a relaxation time of 120 sec, in order to quantitatively integrate the carbonyl signals of oxazolidone, urethane and (meth)acrylate carbonyls)
GPC (Waters Alliance 2690 separation module with Waters 2410 Refractive Index Detector, Calibration: SEC_LT4_{—}20011010, Eluent: THF Biosolve, HPLC-grade, flow: 1.0 m/min. Columns: 1*PL Gel Mixed C with guard column (5 μm) and precolumn filter, Temperature: 30° C. (columns and detector) relative to polystyrene standards.
   Description of Test Methods and Calculation Method

The radiation curable compositions prepared in the examples and the comparative experiment were tested by the following test methods.

Methods for Determining Cure Speed

1. Determination of Cure Speed by Dose versus Modulus Measurements

In this method the tensile moduli of a radiation curable coating composition at various doses are determined to obtain a dose versus modulus curve. The cure speed is defined as the dose at which 95% of ultimate modulus value is attained.

For each radiation curable coating composition to be tested, one drawdown (cured film) is prepared at each of a series of doses (J/cm²): 0.2, 0.3, 0.5, 0.75, 1.0, and 2.0 J/cm².

Test specimens for each drawdown are prepared by cutting five test specimens from the center portion of each drawdown. A single measurement of film thickness is made in the center of the area of each specimen to be tested. The modulus of each specimen is measured from a first drawdown. The stress-strain curve is measured beyond 2.5% elongation. This measurement is repeated for each drawdown of the dose-modulus curve. The average modulus is then determined for each drawdown.

A least squares fit is performed of the modulus versus dose data to fit the non-linear equation (3):
modulus=k₁×[1e^{(k}_{₂}^{×dose)}] (3)

The dose-modulus curve is created by plotting the modulus values as a scatter plot and the equation as a line. Error bars representing the standard deviation of each modulus value are included whenever possible. The cure speed of the coating is defined as “the dose at which 95% of the ultimate secant modulus is attained.”

2. Determination of Cure Speed by Real-Time DMA (“RTDMA”)

The basic instrument is the StressTech rheometer, fitted with a UV curing attachment. The main feature of the UV attachment is that the usual lower metal plate is replaced with a quartz plate, allowing UV light to be transmitted to the sample from below.

The UV source is the Bluepoint 2 (made by Dr. Honle Company) which has an iron-doped lamp. A flexible light guide made of quartz fibers leads the light from the lamp to a location below the sample, such that the light can be beamed directly to the bottom of the sample.

The sample dimensions are 8 mm diameter by 0.1 mm thick, as determined by the upper tool of 8 mm diameter, and the instrument gap setting of 0.1 mm.

The best estimate of the UV intensity at the sample position is 105 milliwatts/cm², as measured with an IL1445 radiometer (manufactured by International Light Co). The spectral sensitivity for the detector is virtually identical with the IL390B. This intensity corresponds to about 1 J/cm² in 9.5 seconds. After the sample is loaded and the gap set, the oven doors are closed and nitrogen gas is flowed into the oven for 15 minutes prior to curing the sample. The measurement is performed at 23° C.

When the run is started (zero seconds), 10 Hz oscillation is applied to the liquid sample in the gap. Data acquisition starts at 1 second. At 2 seconds into the run, the software sends a relay signal for opening the shutter of the Bluepoint 2.

The relay combination is a solid-state relay followed by a mechanical relay. Closing of the contacts on the latter initiates opening of the shutter. The delay time of the relay-shutter combination has been measured and estimated to be 0.035 seconds. The shutter is set to open for six seconds after it has received a signal to open. 360 data points are collected for the five seconds that the data are collected, giving 72 data points per second.

G′ and G″ are plotted on a log scale from 100 to 10⁶ Pa in a graph having as the horizontal axis, time, and as the right axis, phase angle.

The time indicated on the graph for G′ to reach 2×10⁴ Pa is the time since the run started. To obtain the time since the UV light began to illuminate the sample, 2.035 seconds is subtracted from the “raw” time to get the true time. The stress (in Pa) vs. time (in seconds) for the RTDMA test follows the polynomial: Stress(t)=100+200t²−13t³. Three replicates are run per sample.

Method for Determining Dry Adhesion

Method for determining adhesion by curing a film, having a thickness of 150 micron, on a glass plate with a dose of 1 J/cm² under nitrogen using a Fusion™ F450 D bulb.

The dry adhesion of a coating sample is tested by using an Universal testing instrument, Instron Model 4201 or equivalent, equipped with an appropriate data system and applications software. Two drawdowns (cured films on glass plates) are prepared per material to be tested. The cured films are conditioned at 23° C.±2° C. and 50±5% relative humidity. Four test specimens are cutted from each drawdown. To minimize the effects of minor sample defects, sample specimens are cut parallel to the direction in which the drawdown of the cured film was prepared. A thin layer of talc can be applied, using a cotton-tipped applicator or equivalant, to the first and third strips on each drawdown to reduce blocking during the adhesion test.

A load cell and pneumatic action grips are installed on the Instron. The crosshead speed on the Instron test instrument is set to 10.00 inch/min. A binder clip is attached to a length of braided nylon string, which is run through a pulley on the coefficient of friction test apparatus and the free end of the wire is clamped in the upper jaw of the Instron testing instrument. The air pressure for the pneumatic grips is turned to 20 psi.

The end of the first strip is peeled back from one of the glass plates about one inch. The plate is placed on the COF support table with the peeled-back end of the specimen facing away from the pulley. The binder clip is attached to the peeled-back end of the specimen. The plate is pulled to put tension on the braided nylon string until the load on the Instron reads positive. The test is continued until the average force value becomes relatively constant. The test is repeated for the four specimens.

The software automatically calculates the average adhesion for the four specimens. The analysis is considered suspect if any of replicates deviates from the average by more than 20% relative, and in that case, is repeated.

Calculation of Boltzmann Averaged Dipole Moment

The Boltzmann averaged dipole moment is calculated in the following way. First, for the heterocyclic group under consideration a set of starting configurations is generated by considering all possible bond rotations. This is done by means of the Discover 95 program (Computational results obtained using software programs from Molecular Simulations—force field calculations were done with the Discover® program, using the CVFF forcefield, semi-empirical calculations were done the MOPAC 6.0 program).

Torsional angles considered depend on the type of bond, e.g. for a bond between two sp³ carbons the angles taken into account are those corresponding to the two possible gauche conformations and the trans conformation. The number of configurations generated is thus dependent on both the number of bonds and their type. E.g. for three sp³ like bonds one has 3⁵=243 configurations. As a consequence, for some of the acrylates, the total number of configurations was a few thousand.

All these configurations are then minimized at the AM1 level using MOPAC 6.0 with the convergence criterion for the maximum gradient (GNORM) set to 0.05. The resulting structures are then sorted by energy and only the unique structures having a heat of formation differing less than 3 kcal/mole from the heat of formation of the global minimum structure are retained. Whether or not structures are unique is determined by comparing their heats of formation and their dipole moments in the following way. First, structures are considered to be identical if their heats of formation differ at most 0.01 kcal/mole. Nevertheless, structures which are considered to be identical based on this energy criterion are considered to be unique if their dipole moments differ more than 0.2 Debye.

Having determined the unique structures, the Boltzmann weighted dipole moment is consequently evaluated as given by formula (4):

$$< D >= {\sum }_{j} {D}_{j} \frac{{ⅇ}^{- Δ {H}_{j} / RT}}{{\sum }_{i} {ⅇ}^{- Δ {H}_{i} / RT}} = {\sum }_{j} {D}_{j} {p}_{j} \qquad ( 4 )$$

with D j the dipole moment of conformation j, ΔH j the difference between the heat of formation of conformation j and the heat of formation of the global minimum conformation, T the absolute temperature and R the Boltzmann constant, p j is the probability of finding the molecule in conformation j at the temperature T. T is set to 298.15 K. The summation over j runs over all unique structures. Sorting of structures, retaining only the unique ones and the calculation of <D> is done by means of a FORTRAN program developed in.
The advantage of considering the Boltzmann weighted dipole moment instead of the dipole moment of the global minimum structure is that the former takes into account the fact that several conformations can be accessible at T. It is obvious that when the dipole moments of the accessible conformations are significantly different, the value of <D> may be significantly different from the dipole moment of the global minimum. The Boltzmann weighted dipole moment therefore provides a much more realistic description of the system.

### EXPERIMENTAL SECTION

The epoxy functional compounds used in the examples were purchased from EMS.

### Example I

### Synthesis of Oxazolidone Urethane Acrylate Functional Polytetrahydrofuran (polyTHF) (Compound A)

A 500 ml glass reactor equipped with a stirrer, dry air inlet, reflux condensor and dropping funnel was charged with 102 g 4,4,methylene bis (cyclohexyl isocyanates) (HMDI), 1.1 g tri butyl phosphine oxide, 0.3 g lithium bromide and 0.3 g bis(2,4-di-t-butyl-phenyl) pentaerythritol diphosphite (Ultranox 626™ General Electric). The mixture was stirred at 80° C. until all the lithium bromide was dissolved after which the temperature was raised to 130° C. 152 g polyTHF diglycidyl ether (Mn 780) was added at 130° C. at a rate of +500 ml/hour. After the addition was completed the reaction mixture was kept at 130° C. for 1 hour, after which 0.3 g dibutyl-hydroquinone (DBH) and 0.3 g di butyl tin dilaurate (DBTDL) was added followed by decreasing the reaction temperature to 80° C. Dry air was purged trough the reaction mixture and 45 g 2-hydroxy ethyl acrylate (HEA) was added slowly, under dry air bubbling through the reaction mixture, at such a rate that the temperature was kept below 100° C. After the addition was complete the reaction mixture was kept at 80° C. for 1 hour after which no isocyanate could be detected using IR, resulting in oxazolidone urethane acrylate functional compound A with the following characteristics:

GPC: Mn=2400 kg/kmol, D=2.8 (D=Mw/Mn; Mw=weight average molecular weight, Mn=number average molecular weight).

¹³C-NMR carbonyl ratio's oxazolidone/urethane/acrylate=2/2/2

### Example II

### Synthesis of Oxazolidone Urethane Acrylate Functional polyTHF (Compound B)

A 300 ml glass reactor equipped with a stirrer, dry air inlet, reflux condensor and dropping funnel was charged with 61 g HMDI, 0.7 g tri butyl phosphine oxide, 0.2 g lithium bromide and 0.3 g Ultranox 626™. The mixture was stirred until all the lithium bromide was dissolved at 80° C. after which the temperature was raised to 130° C. 121 g polyTHF diglycidyl ether (Mn 780) was added at 130° C. at a rate of ±500 ml/hour. After the addition was completed the reaction mixture was kept at 130° C. for 1 hour, after which 0.2 g dibutyl-hydroquinone (DBH) and 0.2 g DBTDL was added followed by decreasing the reaction temperature to 80° C. Dry air was purged trough the reaction mixture and 18 g HEA was added slowly, under dry air bubbling through the reaction mixture, at such a rate that the temperature was kept below 100° C. After the addition was complete the reaction mixture was kept at 80° C. for 1 hour after which no isocyanate could be detected using IR, resulting in oxazolidone urethane acrylate functional compound B with the following characteristics:

GPC: Mn=3800, D=2.9.

¹³C-NMR carbonyl ratio's oxazolidone/urethane/acrylate=4/2/2

### Example III

### Synthesis of Oxazolidone Urethane Acrylate Functional Polypropylene Glycol PPG (Compound C)

A 300 ml glass reactor equipped with a stirrer, dry air inlet, reflux condensor and dropping funnel was charged with 58 g HMDI, 0.7 g tri butyl phosphine oxide, 0.2 g lithium bromide and 0.2 g Ultranox 626™. The mixture was stirred until all the lithium bromide was dissolved at 80° C. after which the temperature was raised to 130° C. 105 g polypropylene glycol diglycidyl ether (Mn 710) was added at 130° C. at a rate of ±500 ml/hour. After the addition was completed the reaction mixture was kept at 130° C. for 1 hour, after which 0.2 g dibutyl-hydroquinone (DBH) and 0.2 g DBTDL was added followed by decreasing the reaction temperature to 80° C. Dry air was purged trough the reaction mixture and 17 g HEA was added slowly, under dry air bubbling through the reaction mixture, at such a rate that the temperature was kept below 100° C. After the addition was complete the reaction mixture was kept at 80° C. for 1 hour after which no isocyanate could be detected using IR, resulting in oxazolidone urethane acrylate functional compound C with the following characteristics:

GPC: Mn=3700, D=3.0;

¹³C-NMR carbonyl ratio's oxazolidone/urethane/acrylate=4/2/2

### Example IV

### Synthesis of Oxazolidone Urethane Acrylate Functional PPG (Compound D)

A 300 ml glass reactor equipped with a stirrer, dry air inlet, reflux condensor and dropping funnel was charged with 63 g HMDI, 0.7 g tri butyl phosphine oxide, 0.2 g lithium bromide and 0.2 g Ultranox 626™. The mixture was stirred until all the lithium bromide was dissolved at 80° C. after which the temperature was raised to 130° C. 130 g poly propylene glycol diglycidyl ether (Mn 710) was added at 130° C. at a rate of ±500 ml/hour. After the addition was completed the reaction mixture was kept at 130° C. for 1 hour, after which 0.2 g dibutyl-hydroquinone (DBH) and 0.2 g DBTDL was added followed by decreasing the reaction temperature to 80° C. Dry air was purged trough the reaction mixture and 14 g HEA was added slowly, under dry air bubbling through the reaction mixture, at such a rate that the temperature was kept below 100° C. After the addition was completed the reaction mixture was kept at 80° C. for 1 hour after which no isocyanate could be detected using IR, resulting in oxazolidone urethane acrylate functional compound D with the following characteristics:

GPC: Mn=5700, D=3.2;

¹³C-NMR carbonyl ratio's oxazolidone/urethane/acrylate=6/2/2

### Example V

### Synthesis of Oxazolidone Urethane Acrylate Based on In Situ Prepared Block Co-Polymer of Poly THF and PPG (Compound E)

A 300 ml glass reactor equipped with a stirrer, dry air inlet, reflux condensor and dropping funnel was charged with 63 g HMDI, 0.7 g tri butyl phosphine oxide, 0.2 g lithium bromide and 0.4 g Ultranox 626™. The mixture was stirred until all the lithium bromide was dissolved at 80° C. after which the temperature was raised to 130° C. A mixture of 62 g polyTHF diglycidyl ether (Mn 780) and 57 g poly propylene glycol diglycidyl ether (Mn 710) was added at 130° C. at a rate of +500 ml/hour. After the addition was completed the reaction mixture was kept at 130° C. for 1 hour, after which 0.2 g dibutyl-hydroquinone (DBH) and 0.2 g DBTDL was added followed by decreasing the reaction temperature to 80° C. Dry air was purged trough the reaction mixture and 18.5 g HEA was added slowly, under dry air bubbling through the reaction mixture, at such a rate that the temperature was kept below 100° C. After the addition was complete the reaction mixture was kept at 80° C. for 1 hour after which no isocyanate could be detected using IR, resulting in oxazolidone urethane acrylate functional compound F with the following characteristics:

GPC: Mn=4700, D=2.8;

¹³C-NMR carbonyl ratio's oxazolidone/urethane/acrylate=4/2/2

Example I demonstrates the preparation of the compounds according to the invention by the process according to the invention. Examples II-IV demonstrate that the oxazolidone forming reaction can be employed for elongation of the polymer chain. Example V demonstrates that this oxazolidone forming reaction can be used for the formation of block co polymers

### Example VI

### UV Curable Composition Containing Compound B as Oligomer

A formulation was prepared containing: 52.8 wt. % compound B as oligomer, 9.5 wt. % N-vinyl caprolactam, 8.64 wt. % ethoxylated nonyl phenol acrylate (Sartomer SR504D), 9.22 wt. % lauryl acrylate and 15.84 wt. % isobornyl acrylate as reactive diluents, 3 wt. % Lucerin TPO as photoinitiator and 1 wt. % silane adhesion promotor γ-mercapto propyl trimethoxy silane (A-189 from OSi Specialties).

Cure Speed:

The cure speed of this formulation determined according to the dose modulus method was 0.06 J/cm². The time to reach a G′ 2×10⁴ Pa was 0.05 sec.

Adhesion:

An 150 micron film was cured with as dose of 1 J/cm2 under nitrogen using a Fusion F450 D bulb, resulting in a cured film with the following characteristics.

Modulus: 1.5 MPa, elongation: 231%, Dry adhesion to glass: >600 g/in (film broke before delamination occurred)

### Example VII

### UV Curable Composition Containing Compound C as Oligomer

A formulation was prepared containing: 52.8% compound C as oligomer, 9.5% N-vinyl caprolactam, 8.64% ethoxylated nonyl phenol acrylate (Sartomer SR504D), 9.22% lauryl acrylate and 15.84% isobornyl acrylate as reactive diluents, 3% Lucerin TPO as photoinitiator and 1% silane adhesion promotor (A-189).

Cure Speed:

The cure speed of this formulation was according to the dose modulus method 0.06 J/cm². The time to reach a G′ 2×10⁴ Pa was 0.05 sec.

Adhesion:

An 150 micron film was cured with as dose of 1 J/cm2 under nitrogen using a Fusion F450 D bulb. resulting in a cured film with the following characteristics.

Modulus: 2.5 MPa, elongation: 200%, Dry adhesion to glass: >600 g/in (film broke before delamination occurred)

### Example VIII

### UV Curable Composition Containing Compound E as Oligomer

A formulation was prepared containing: 52.8% compound F as oligomer, 9.5% N-vinyl caprolactam, 8.64% ethoxylated nonyl phenol acrylate (sartomer SR504D), 9.22% lauryl acrylate and 15.84% isobornyl acrylate as reactive diluents, 3% Lucerin TPO as photoinitiator and 1% silane adhesion promotor (A-189).

Cure Speed:

The cure speed of this formulation was according to the dose modulus method 0.06 J/cm². The time to reach a G′ 2×10⁴ Pa was 0.09 sec.

Adhesion:

An 150 micron film was cured with as dose of 1 J/cm2 under nitrogen using a Fusion F450 D bulb. resulting in a cured film with the following characteristics.

Modulus: 2.1 MPa, elongation: 220%, Dry adhesion to glass: >600 g/in (film broke before delamination occurred)

### Comparative Experiment A

Oligomer 1 was prepared from 2 equivalents hydroxy ethyl acrylate, 3 equivalents isophorone diisocyanate and 2 equivalents of pTGL 2000 (a copolymer of THF and 3-methyl THF). This polyTGL urethane acrylate oligomer has a theoretical Mn of 4900.

A formulation was prepared containing: 52.8% oligomer 1, 9.5% N-vinyl caprolactam, 8.64% ethoxylated nonyl phenol acrylate (Sartomer SR504D), 9.22% lauryl acrylate and 15.84% isobornyl acrylate as reactive diluents, 3% Lucerin TPO as photoinitiator and 1% silane adhesion promotor (A-189).

Cure Speed:

The cure speed of this formulation was according to the dose modulus method 0.19 J/cm². The time to reach a G′ 2×10⁴ Pa was 0.12 sec.

Adhesion:

An 150 micron film was cured with as dose of 1 J/cm2 under nitrogen using a Fusion F450 D bulb, resulting in a cured film with the following characteristics.

Modulus: 1.4 MPa, elongation: 260%, Dry adhesion to glass: 215 g/in

Example VI and comparative experiment A (for which similar oligomer backbones have been used) clearly demonstrate that radiation curable coating compositions according to the invention cure faster as demonstrated with the dose modulus technique as well as with real time DMA.

Furthermore examples VI-VIII and comparative experiment A demonstrate that the adhesion to glass is enhanced when applying radiation curable coating compositions according to the invention.

1. Radiation curable coating composition comprising
(A) a compound according to P— (D-(meth)acrylate)ₙ having a number average molecular weight (Mn) of at least 500 kg/kmol, wherein
n=2-40,
P=oligomeric or polymeric backbone, and
D comprises an urethane group and an heterocyclic group, said heterocyclic group having a Boltzmann average dipole moment of at least 2.5 Debye, and
(B) a reactive diluent.

2. Radiation curable coating composition according to claim 1, wherein the heterocyclic group is an oxazolidone group.

3. Radiation curable coating composition comprising:
(A) a compound, comprising an oxazolidone group, an urethane group and an (meth)acrylate group and having a number average molecular weight (Mn) of at least 500 kg/kmol and
(B) a reactive diluent.

4. Radiation curable coating composition according to claims 13 claim 1, wherein the compound (A) is a compound according to Formula I: 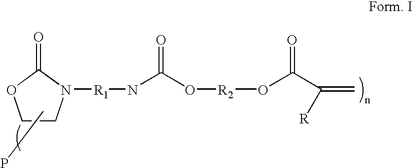
in which
P=oligomeric or polymeric backbone which is connected to either the 4 or 5 position of the oxazolidone
n=2-40
R=H, C₁-C₅ alkyl
R₁=C₁-C₃₀ alkyl, cycloalkyl, aryl, alkylaryl
R₂=C₁-C₁₂ alkyl, cycloalkyl, aryl, alkylaryl, alkoxy alkyl, alkoxy aryl,
or a compound according to Formula II: 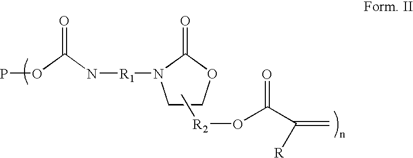
in which:
P=oligomeric or polymeric backbone
n=2-40
R=H, C₁-C₅ alkyl
R₁=C₁-C₃₀ alkyl, cycloalkyl, aryl, alkylaryl
R₂=C₁-C₁₂ alkyl, cycloalkyl, aryl, alkylaryl, alkoxy alkyl, alkoxy aryl, which R₂ is connected to either the 4 or 5 position of the oxazolidone.

5. Composition according to claim 1, wherein n=2−10.

6. Composition according to claim 5, wherein n=2.

7. Composition according to claim 4, wherein R=H or CH₃.

8. Composition according to claim 4, wherein R₁ is a C₂-C₂₀ alkyl, cycloalkyl, aryl or arylalkyl.

9. Composition according to claim 1, in which R₁ is a cycloalkyl.

10. Composition according to claim 9, wherein R₁ is cyclohexyl.

11. Composition according to claim 9, wherein R₁ is

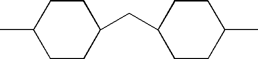

12. Composition according claim 4, wherein R₂=methyl, ethyl, 1-propyl, 2-propyl, butyl, ethoxyethyl.

13. Compounds as defined in claim 4, wherein R₁ is 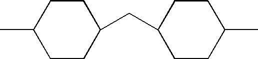
and R₂ is ethyl.

14. Method for producing a resin composition comprising a compound comprising an oxazolidone group and an (meth)acrylate group, said method comprising a reaction step introducing the (meth)acrylate group into the compound, wherein said reaction step is carried out in the presence of an antioxidant.

15. Method according to claim 14, wherein the compound comprises an oxazolidone group, an urethane group and an (meth)acrylate group.

16. Method according to claim 14, wherein the antioxidant is a phenolic antioxidant.

17. Method according to claim 14, wherein during the reaction step introducing the (meth)acrylate group into the compound, oxygen or an oxygen containing gas mixture is lead into the reaction mixture.

18. Method according to claim 14, wherein the (meth)acrylate group is introduced into the compound during the last reaction step.

19. Resin composition obtainable according to the process of claim 14.

20. A compound according to formula I: 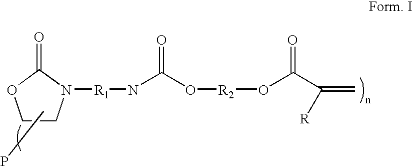
in which
P=oligomeric or polymeric backbone which is connected to either the 4 or 5 position of the oxazolidone
n=2−40
R=H, C₁-C₅alkyl
R₁=C₁-C₃₀alkyl, cycloalkyl aryl, alkylaryl
R₂=C₁-C₁₂ alkyl, cycloalkyl, aryl, alkylaryl, alkoxy alkyl, alkoxy aryl.

21. A radiation curable coating composition comprising a radiation curable oligomer, a reactive diluent and a photoinitiator in such amounts that said composition, when cured, shows
(i) a cure speed of less than about 0.11 sec when measured by real time DMA as the time needed to reach a G′of 2×10⁴ Pa, and
(ii) a dry adhesion of at least about 250 g/in.

22. (canceled)

23. Coated optical fiber comprising a glass optical fiber, a primary coating and a secondary coating, wherein said primary coating comprises a composition according to claim 1, when cured.

24. A method for forming an optical fiber comprising applying a radiation curable composition according to claim 1 to an optical fiber and curing the curable composition.
